(19) United States
(12) Patent Application Publication
(10) Pub. No.: US 2009/0197557 A1
(43) Pub. Date: Aug. 6, 2009

(54) Differential diversity antenna

(76) Inventors: Thomas H. Lee, Burlingame, CA (US); Bendik Kleveland, Santa Clara, CA (US)

Correspondence Address: BRINKS HOFER GILSON & LIONE, P.O. BOX 10395, CHICAGO, IL, 60610, US

(21) Appl. No.: 12/012,714

(22) Filed: Feb. 4, 2008

(51) Int. Cl. H04B 1/18

(52) U.S. Cl. 455/272

(57) ABSTRACT

A differential diversity antenna is provided. In one embodiment, a differential diversity antenna is used in a wireless system comprising receiver circuitry. (and, in another embodiment, transmission circuitry). The differential diversity antenna comprises a plurality of antenna components that are aligned non-collinearly to achieve diversity. In another embodiment, the differential diversity antenna is used with a second differential diversity antenna. Other embodiments are disclosed, and each of the embodiments can be used alone or together in combination.

### BACKGROUND

Many conventional antennas are responsive to only one polarization or are “omnidirectional” in only one plane. Furthermore, most conventional antennas are single-ended and, therefore, require an element, such as a balun, to interface with differential circuitry. In general, the link quality of wireless systems improves if the antenna is sensitive to a plurality of polarizations and signal directions. A great deal of effort has been expended to implement diversity systems. Most use a plurality of antennas and electronics. An example of a maximal ratio combining method of single dipoles is found in “Wireless Communications: Principles and Practice,” T. S. Rappaport, pages 325-331 (1996).

### SUMMARY

The present invention is defined by the claims, and nothing in this section should be taken as a limitation on those claims.

By way of introduction, the embodiments described below provide a differential diversity antenna. In one embodiment, a differential diversity antenna is used in a wireless system comprising receiver circuitry (and, in another embodiment, transmission circuitry). The differential diversity antenna comprises a plurality of antenna components that are aligned non-collinearly to achieve diversity. In another embodiment, the differential diversity antenna is used with a second differential diversity antenna. Other embodiments are disclosed, and each of the embodiments can be used alone or together in combination.

The embodiments will now be described with reference to the attached drawings.

### BRIEF DESCRIPTION OF THE DRAWINGS

FIG. 1 is an illustration of prior art transmission and reception principles involved with wireless signals.

FIG. 2A is an illustration of an ideal received wireless signal of the prior art.

FIG. 2B is an illustration of a fading received wireless signal of the prior art.

FIG. 3 is an illustration of a prior art diversity receiver.

FIG. 4 is a graph showing receive power with and without using a prior art diversity receiver.

FIG. 5A is an illustration of a diversity antenna of the prior art with two straight, parallel dipoles.

FIG. 5B is an illustration of a differential diversity antenna of an embodiment whose antenna elements are aligned non-collinearly.

FIG. 5C is an illustration of a differential diversity antenna of an embodiment whose antenna elements are aligned in x, y, and z directions.

FIG. 6A is an illustration of prior art antennas in x and y directions.

FIG. 6B is an illustration of independent antennas of an embodiment in x and y directions with space diversity.

FIG. 7 is a block diagram of a system of an embodiment using a balun.

FIG. 8 is a block diagram of a system of an embodiment that does not use a balun.

FIG. 9 is a block diagram of a system of an embodiment using an impedance transformer.

FIG. 10 is a block diagram of a system of an embodiment that does not use an impedance transformer.

FIG. 11 is a block diagram of a system of an embodiment with a diversity receiver and combining circuit.

### DETAILED DESCRIPTION OF THE PRESENTLY PREFERRED EMBODIMENTS

The following embodiments generally relate to a differential diversity antenna. In these embodiment, unlike the prior art, a differential structure is presented whose antenna elements are aligned non-collinearly to achieve diversity. Because it is improbable that neither element is positioned to intercept incoming energy, diversity reception (and its dual, diversity transmission) occurs naturally. Before turning to the details of such a differential structure, an overview is provided of issues related to reception of wireless signals by antennas.

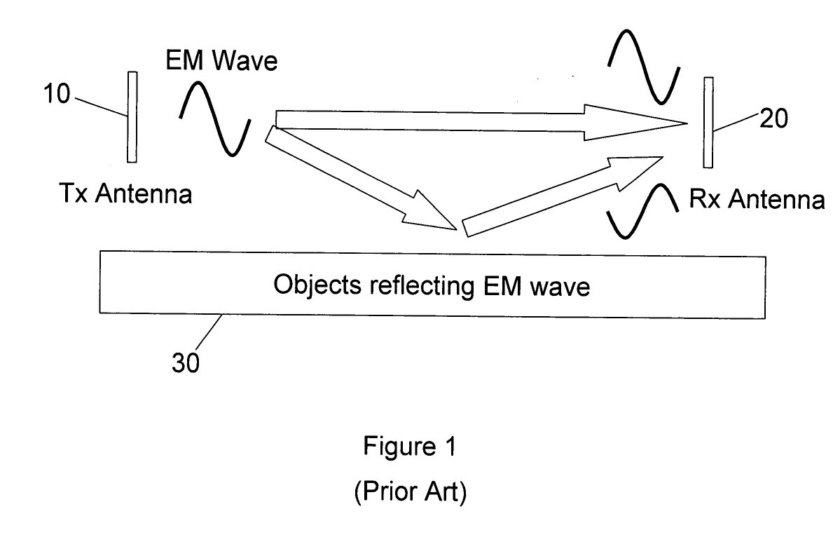

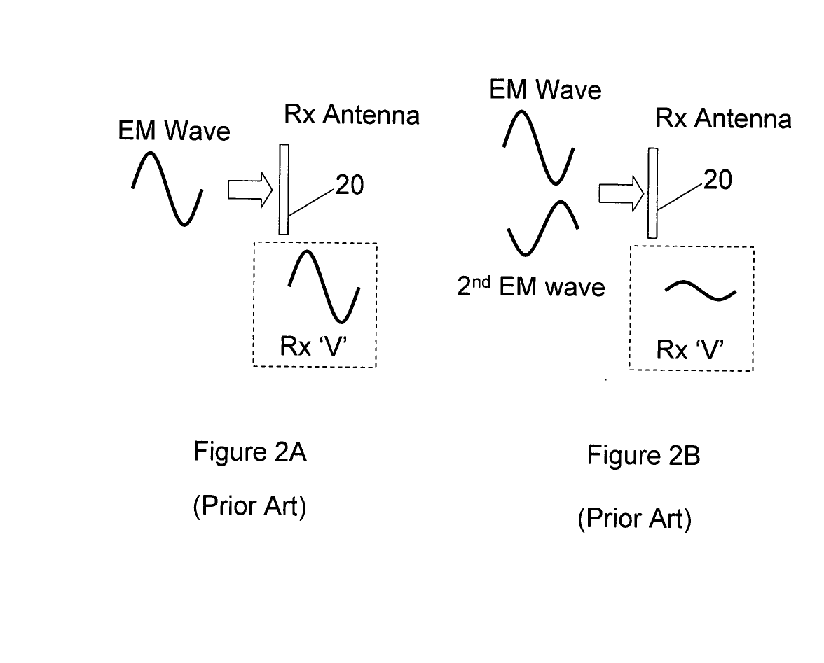

FIG. 1 illustrates the basic transmission and reception principles involved with wireless signals. As shown in FIG. 1, an electromagnetic wave (i.e., a wireless signal) is transmitted by a transmitting antenna (Tx) 10. When the wireless signal arrives at the receiving antenna (Rx) 20, it may be a combination of multiple paths. For example, there could be a straight path from the transmitting antenna 10 to the receiving antenna 20, as well as one or more paths that have reflected from objects 30 along the way. The phases of these incoming waves can either add or subtract at the receiving antenna 20. If they add, the resulting signal would be stronger than the signal transmitted by the transmitting antenna 10. However, if they subtract, the resulting signal can be smaller than the signal transmitted by the transmitting antenna 10 and possibly fade below the sensitivity of the receiver (not shown) in communication with the receiving antenna 20. This is illustrated further in FIGS. 2A and 2B. FIG. 2A illustrates an ideal received wireless signal. Here, the incoming electromagnetic wave induces a voltage waveform “V” at the receiver antenna 20. However, in FIG. 2B, which illustrates a fading received wireless signal, two incoming electromagnetic waves subtract. That is, the waves almost cancel each other out because they are 180 degrees out of phase. The resulting receiver waveform “V” at the receiver antenna 20 is, therefore, much smaller and more difficult to detect by the receiver.

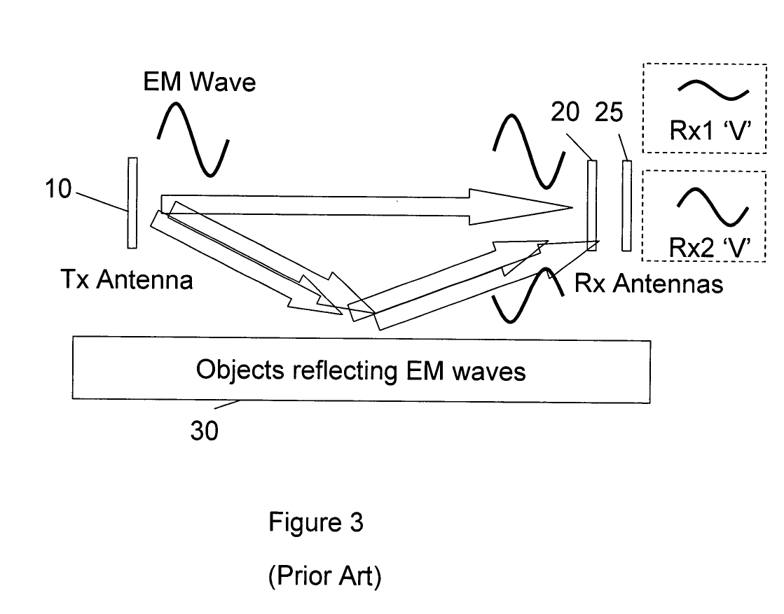

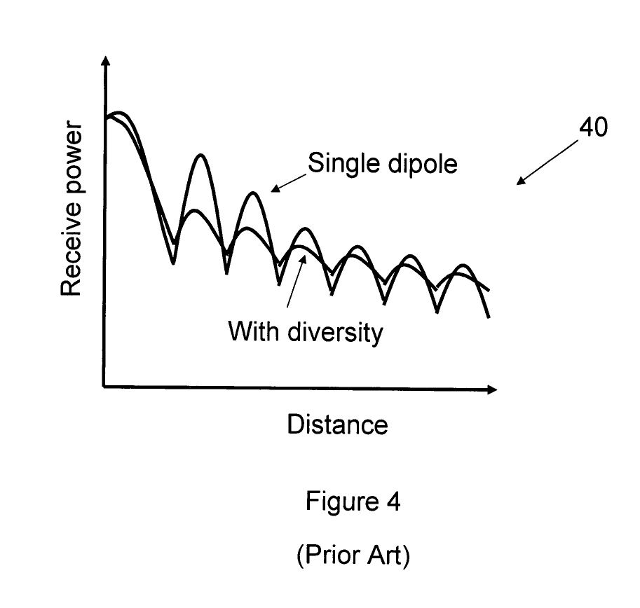

To compensate for this situation, space diversity can be used, as described in more detail in J. D. Kraus, “Antennas,” Second edition, McGraw-Hill and “Wireless Communications: Principles and Practice,” T. S. Rappaport, pages 325-331 (1996). In general, as shown in FIG. 3, space diversity uses two receiving antennas 20, 25 that are spaced apart, typically less than one wavelength of the electromagnetic wave. The probability of the wireless signals canceling/fading at both the first and second receiving antennas 20, 25 is much lower than that of one antenna. FIG. 4 is a graph 40 showing receive power with and without diversity. As shown in this graph 40, the peak power may be slightly smaller with diversity, but, more importantly, the troughs are not as deep, so range is improved.

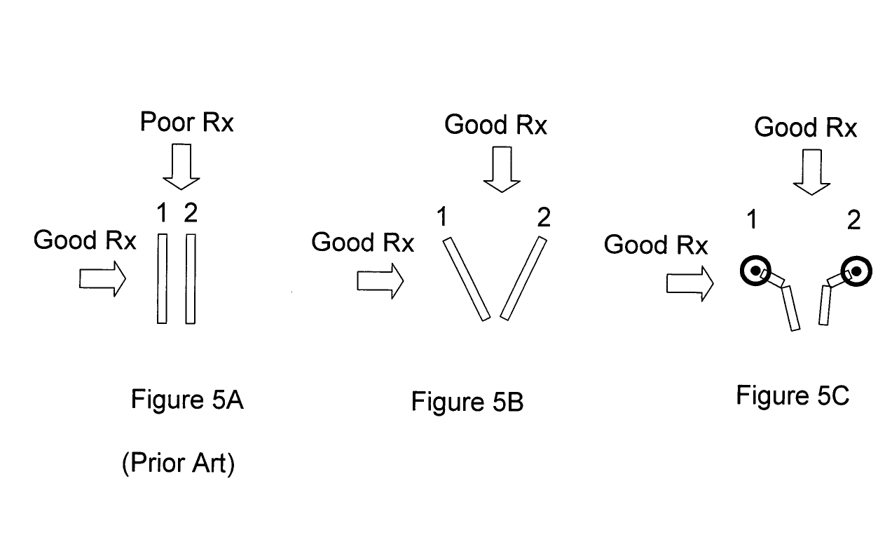

One difficulty with conventional diversity antennas with two straight, parallel dipoles is that they are responsive to only one polarization or are “omnidirectional” in only one plane. This is illustrated in FIG. 5A, where an incoming horizontal wave is polarized such that the electric field is aligned with the vertical antennas 1, 2. The horizontal reception is good (“Good Rx”) because the vertical lines intercept the vertical electric field lines of the incoming horizontal wave. However, the vertical reception is poor (“Poor Rx”) because the polarization of the incoming wave does not match that of the antenna, and the electric field lines do not induce any voltage in the vertical antennas.

To address this situation, the following embodiments use a differential structure whose antenna elements are aligned non-collinearly to achieve diversity. Because it is improbable that neither element is positioned to intercept incoming energy, diversity reception (and its dual, diversity transmission) occurs naturally. For example, as shown in FIG. 5B, the two antennas are not aligned in parallel, and the additional horizontal/vertical diversity improves the reception from both directions. By separating out the differential antenna, the reception can be improved over simple parallel lines. As another example, as shown in FIG. 5C, the antennas do not be need to be straight lines. Instead, they route with components in x, y, and z directions (in FIG. 5C, the z direction is coming out of page, as illustrated by the dot in the circle), providing even better diversity.

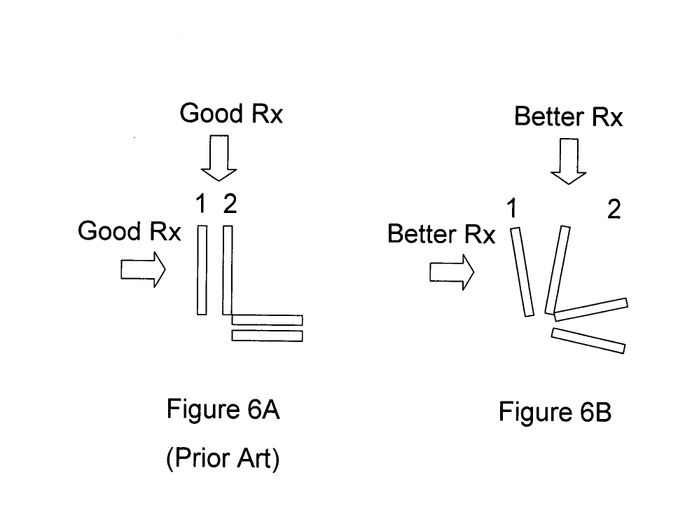

In another embodiment, independent antennas are presented in x, y, and z directions and are then combined. Prior art differential antenna in both x and y can be driven in parallel to providing good polarization diversity. This is shown in FIG. 6A. With such an arrangement, good transmission is possible even when the wireless signal is orthogonal to two of the receiving antennas. However, in this embodiment, which is shown in FIG. 6B, even better transmission is achieved by using non-parallel lines to also provide some space diversity. In many low-cost wireless applications, the area of the antenna is limited to a plane, so this concept may be limited to only x-y as shown below. However, if the unit is big enough to handle x, y, and z direction, three polarizations can be combined to provided improved reception.

One issue with having several pairs of antenna is that the antenna impedance will be reduced. Thus, an impedance transformation circuit may be required from a conventional RF front-end circuit, typically designed for 50 ohms. (Such circuits are described in T. H Lee, “The design of CMOS radio-frequency integrated circuits,” Cambridge.) However, if the antenna and front-end circuits are co-designed, the lower impedance of the diversity antennas is compatible with the technology scaling that is trending towards progressively lower voltage; therefore, lower impedance for a given power (P=V²/R) is provided. Further, this co-designed front-end circuit may ultimately save power because the requirement of the sensitivity of a low noise amplifier (LNA) is reduced with the improved diversity of the antenna.

With the antenna structures of these embodiment now described, the following paragraphs will describe some exemplary systems that can be used with these antenna structures. It should be noted that these systems are merely examples and other systems can be used. Accordingly, details of these systems should not be read into the claims unless explicitly recited therein.

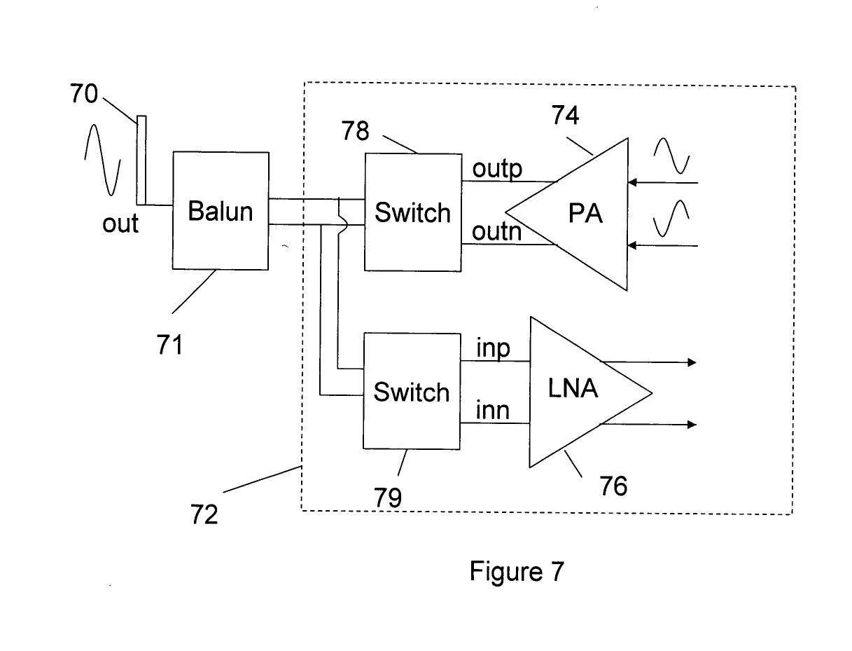

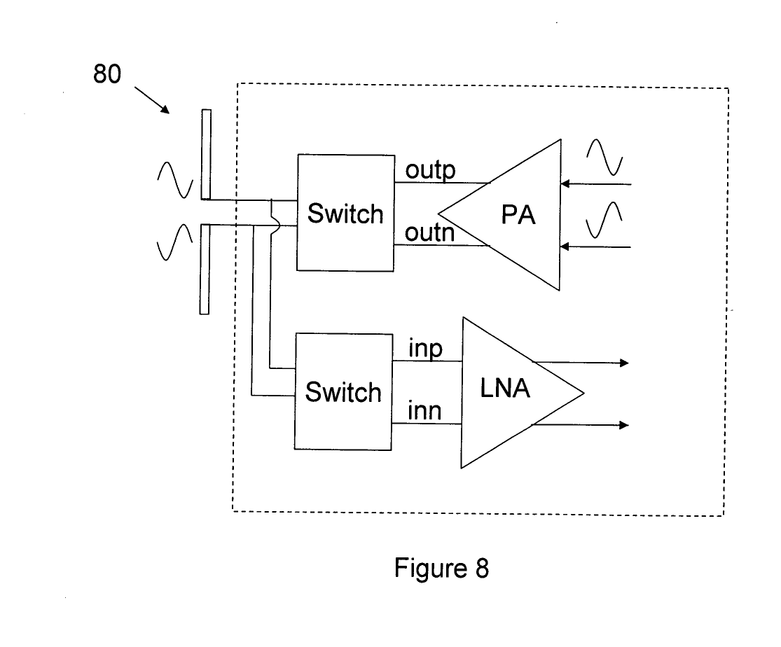

Returning to the drawings, in the system shown in FIG. 7, an antenna 70 is in communication with an integrated circuit (“chip”) 72 via a balun 71. The integrated circuit 72 comprises a power amplifier (“PA”) 74, which acts as a transmitter, and a low noise amplifier (“LNA”) 76, which acts as a receiver. The integrated circuit 72 also comprises switches 78, 79 between the balun 71 and the power amplifier 74 and low noise amplifier 76, respectively. The signals are generally differential on the integrated circuit 72 as illustrated with the positive (outp) and negative (outn) signals between the components. The positive and negative signals make the information robust to common mode variations, such as supply variations, as described in T. H Lee, “The design of CMOS radio-frequency integrated circuits,” Cambridge. If a single-ended antenna 70 is used, as shown in FIG. 7, the balun 71 can be used to change from a two-wire (balanced) signal to a single-ended (unbalanced) signal. As shown in FIG. 7, this requires an external component or several discrete components. Alternatively, if a differential antenna 80 is used (see FIG. 8), there is no need for an external balun. The combination of the positive and negative signals is done by the differential antenna 80.

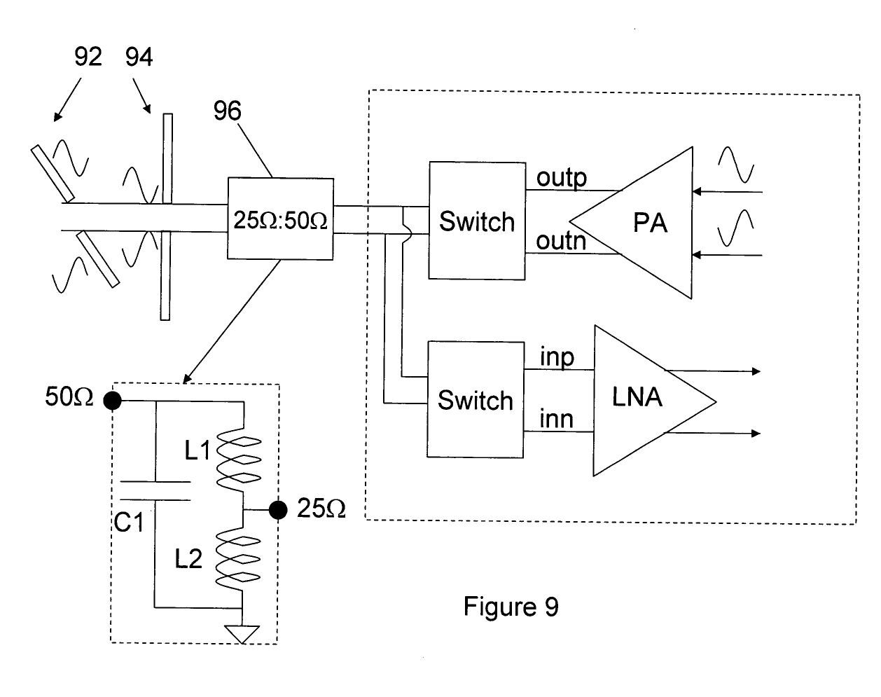

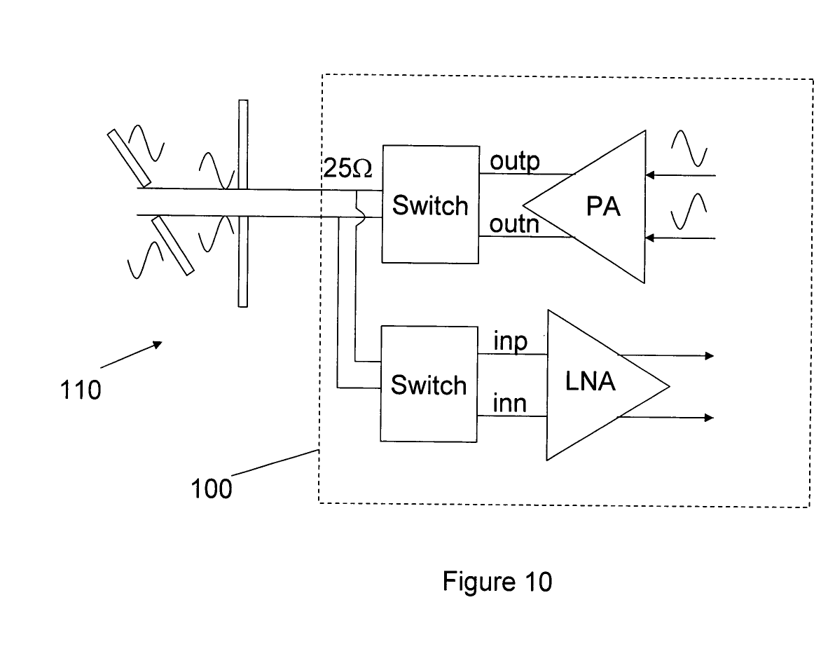

As noted above, it is generally preferred to match internal impedance with external impedance. FIG. 9 is an illustration of a system in which two differential antennas 92, 94 are connected after an impedance transformer 96. Here, the impedance transformer 96 transforms a 25 Ohm impedance to a 50 Ohm impedance. FIG. 9 also shows an exemplary transformer that can be used comprising a capacitor C1 and two inductors L1, L2. Such a transformer is discussed in more detail in T. H Lee, “The design of CMOS radio-frequency integrated circuits,” Cambridge. Again, an impedance transformer generally requires more passive components on or off chip. It should be noted that an impedance transformer is not needed in all embodiments. For example, as shown in FIG. 10, if the on-chip impedance is tailored to the external impedance (i.e., the chip 100 is already matched to the antenna 110), there is no need for an impedance transformer. In the embodiment shown in FIG. 10, there is a 25 ohm impedance on and off chip 100.

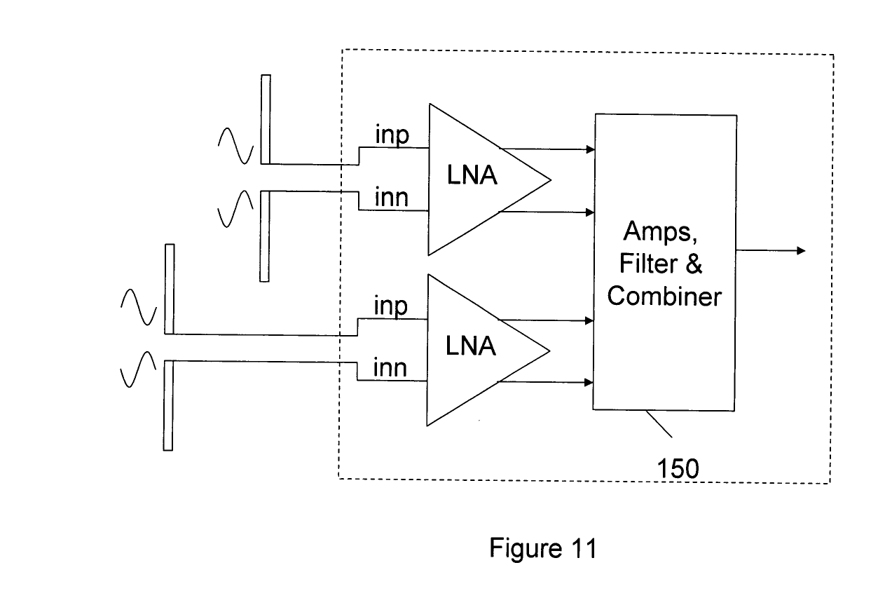

One of the advantages of these embodiments is that by moving the “intelligence” to the design of the antenna, improved performance can be achieved at no additional cost in power, area, and complexity. For example, as shown in “Wireless Communications: Principles and Practice,” T. S. Rappaport, pages 325-331 (1996), wireless systems generally have more circuitry on the receiver than the simple LNA/receiver chain illustrated above. This is illustrated in FIG. 11 by the amps, filter & combiner element 150, which provides better performance at the added cost of power, area, and complexity of design. Again, with these embodiments, improved performance can be achieved at no additional cost in power, area, and complexity by moving the “intelligence” to the design of the antenna.

It should be noted that the integrated circuits and antenna components described above can be used in any suitable electronic device. For example, the integrated circuits and antenna components can be used on a portable wireless device, such as, but not limited to, a mobile phone, a digital media player (e.g., MP3 player), a text message/email device, a navigation device, etc. Finally, it should be understood that a “circuit” (or “circuitry”), as that term is used herein, can be implemented in any suitable manner and with any suitable components and should not be limited to any particular type of implementation described herein. A “circuit” can take the form of, for example, a set of basic hardware components (e.g., transistors, resistors, etc.), an application specific integrated circuit (ASIC), a programmable logic controller, an embedded microcontroller, and a single-board computer. Also, while a circuit can be implemented purely with hardware, a circuit can also be implemented with both hardware and software (e.g., a processor running computer-readable program code). Further, one component can be “in communication” with another component directly or indirectly through one or more components named or unnamed herein, either through a physical or wireless medium. Also, an output of one component can be provided as an input to another component when the output is in direct communication with the input or is in indirect communication with the input through one or more components named or unnamed herein, either through a physical or wireless medium.

It is intended that the foregoing detailed description be understood as an illustration of selected forms that the invention can take and not as a definition of the invention. It is only the following claims, including all equivalents, that are intended to define the scope of this invention.

What is claimed is:

1. A wireless system comprising:
receiver circuitry; and
a differential diversity antenna in communication with the receiver circuitry, wherein the differential diversity antenna comprises a plurality of antenna components that are aligned non-collinearly to achieve diversity.

2. The wireless system of claim 1, wherein at least some of the plurality of antenna components are aligned in x, y, and z directions.

3. The wireless system of claim 1, wherein all of the plurality of antenna components are aligned in x, y, and z directions.

4. The wireless system of claim 1, wherein at least some of the plurality of antenna components are aligned in only two of x, y, and z directions.

5. The wireless system of claim 1 further comprising:
an additional differential diversity antenna in communication with the receiver circuitry, wherein the additional differential diversity antenna comprises an additional plurality of antenna components that are aligned non-collinearly to achieve diversity.

6. The wireless system of claim 5, wherein at least some of the additional plurality of antenna components are aligned in x, y, and z directions.

7. The wireless system of claim 5, wherein all of the additional plurality of antenna components are aligned in x, y, and z directions.

8. The wireless system of claim 5, wherein at least some of the additional plurality of antenna components are aligned in only two of x, y, and z directions.

9. The wireless system of claim 1 further comprising:
transmission circuitry in communication with the differential diversity antenna.

10. A wireless system comprising:
receiver circuitry;
a first differential diversity antenna in communication with the receiver circuitry; and
a second differential diversity antenna in communication with the receiver circuitry;
wherein the first and second differential diversity antennas each comprise a plurality of antenna components that are aligned non-collinearly to achieve diversity.

11. The wireless system of claim 10, wherein at least some of the plurality of antenna components of at least one of the first or second differential diversity antenna are aligned in x, y, and z directions.

12. The wireless system of claim 10, wherein all of the plurality of antenna components of at least one of the first or second differential diversity antenna are aligned in x, y, and z directions.

13. The wireless system of claim 10, wherein at least some of the plurality of antenna components of at least one of the first or second differential diversity antenna are aligned in only two of x, y, and z directions.

14. The wireless system of claim 10 further comprising:
transmission circuitry in communication with the first and differential diversity antennas.

15. A method for use in a wireless system, the method comprising:
receiving a wireless signal with a differential diversity antenna, wherein the differential diversity antenna comprises a plurality of antenna components that are aligned non-collinearly to achieve diversity; and
providing the wireless signal to receiver circuitry.

16. The method of claim 15, wherein at least some of the plurality of antenna components are aligned in x, y, and z directions.

17. The method of claim 15, wherein all of the plurality of antenna components are aligned in x, y, and z directions.

18. The method of claim 15, wherein at least some of the plurality of antenna components are aligned in only two of x, y, and z directions.

19. The method of claim 15 further comprising receiving a wireless signal with an additional differential diversity antenna comprising an additional plurality of antenna components that are aligned non-collinearly to achieve diversity.

20. The method of claim 19, wherein at least some of the additional plurality of antenna components are aligned in x, y, and z directions.
